(19) United States
(12) Patent Application Publication
(10) Pub. No.: US 2016/0306761 A1
(43) Pub. Date: Oct. 20, 2016

(54) SMART WATCH WITH TRANSMISSION FUNCTION

(71) Applicant: YUAN-HAO LIU, CAOTUN TOWNSHIP (TW)

(72) Inventor: YUAN-HAO LIU, CAOTUN TOWNSHIP (TW)

(21) Appl. No.: 14/686,789

(22) Filed: Apr. 15, 2015

(51) Int. Cl. G06F 13/38; G06F 13/42; G04G 21/00

(52) U.S. Cl. CPC G06F 13/385; G04G 21/00; G06F 13/4282

(57) ABSTRACT

A smart watch with transmission function is disclosed. The smart watch with transmission function includes a movement structure, two transmission watch straps, a first connecting element and a second connecting element. The movement structure includes a judgment unit. The two transmission watch straps connect with respect to the two ends of the movement structure, and thereby connect to the judgment unit. The first connecting element is disposed on one of the two transmission watch straps and opposed to one end of the movement structure. The second connecting element is disposed on another transmission watch strap and opposed to another end of the movement structure.

### BACKGROUND OF THE INVENTION

1. Field of the Invention

The present invention relates to a smart watch, in particular to a smart watch with transmission and storage functions.

2. Description of the Related Art

In general, besides the people who like collecting watches, watches are used for viewing time for most people. However, as the time changes and with the progress of technology, watches only available to be used for viewing time as a single function cannot meet the needs of daily life for people today.

On the other hand, since people today emphasize on the convenience, the rapidity and the high efficiency, after the development of notebook computers, digital cameras, smart phones and other digital devices, flash drives, transmission lines and other peripheral digital products have been also developed successively to strengthen and enhance the storage function and mobility of the digital devices. However, as the flash drives and transmission lines are digital products only with peripheral properties, it is easy for people to forget carrying.

Therefore, how to combine watches with transmission and storage functions in order to facilitate the diversification of the functions of the smart watches as well as reinforce the mobility of the traditional flash drives and transmission lines, is a direction which has to be advanced by the current technology.

### SUMMARY OF THE INVENTION

In view of the above problems of the conventional techniques, the purpose of the present invention is to provide a smart watch with transmission function to solve problems to be improved of the current digital products.

According to the purposes of the present invention, a smart watch with transmission function is provided, which includes a movement structure, two transmission watch straps, a first connecting element and a second connecting element. The movement structure includes a judgment unit. The two transmission watch straps connect with respect to two ends of the movement structure, and thereby connect to the judgment unit. The first connecting element is disposed on one of the two transmission watch straps and opposed to one end of the movement structure. The second connecting element is disposed on another transmission watch strap and opposed to another end of the movement structure. Wherein, when the first connecting member and the second connecting member of the smart watch with transmission function connect to different digital devices respectively, the judgment unit generates a transmission signal correspondingly such that digital data is transmitted between the two digits devices via the smart watch with transmission function. When the first connecting member or the second connecting member is connected to one of the two digital devices, the judgment unit generates a storage signal correspondingly such that the smart watch with transmission function stores the digital data of the digital device.

Preferably, the movement structure may further include a transmission unit, which is connected to the judgment unit and the two transmission watch straps. When the transmission unit receives the transmission signal, the transmission unit transmits the digital data via the two transmission watch straps accordingly.

Preferably, the movement structure may further include a storage unit, which is connected to the judgment unit and the two transmission watch straps. When the storage unit receives the storage signal, the storage unit stores the digital data via one of the two transmission watch straps accordingly.

Preferably, an edge of the movement structure may be configured with an adjustment member.

Preferably, one of the two transmission watch straps may be configured with a plurality of fixing holes.

Preferably, another transmission watch strap may be configured with a fixing member corresponding to the plurality of fixing holes.

Preferably, one of the two transmission watch straps may be configured with a securing member.

Preferably, time display of the smart watch with transmission function may be in pointer-type or electronic-type.

Preferably, the two transmission watch straps and the movement structure may be detachable.

Preferably, the first connecting member and the second connecting member may be universal serial bus.

According to the above, the smart watch with transmission function of the present invention has one or more advantages as follows:

(1) The smart watch with transmission function of the present invention is equipped with two transmission watch straps and a transmission unit, such that the users can use the smart watch serving as a transmission line to connect digital devices, which is convenient for outputting or inputting the digital data directly.

(2) The storage unit of the smart watch with transmission function of the present invention may assist the users to store or read the digital data in anytime and anywhere.

(3) The smart watch with transmission function of the present invention may be switched to different function modes through the judgment unit, such that the smart watch may be connected to the transmission unit or the storage unit according the users' own needs to carry out the operations for transmitting or storing the digital data.

### BRIEF DESCRIPTION OF THE DRAWINGS

FIG. 1 is a block diagram of the smart watch with transmission function of the present invention.

FIG. 2 is a front view of the smart watch with transmission function of the present invention.

FIG. 3 is a side view of the smart watch with transmission function of the present invention.

FIG. 4 is a schematic view of operation for the smart watch with transmission function of the present invention.

### DETAILED DESCRIPTION OF THE PREFERRED EMBODIMENTS

In order to facilitate the understanding of the features, the contents and the advantages of the present invention, and the effectiveness thereof that can be achieved, the present invention will be illustrated in detail below through embodiments with reference to the accompanying drawings. On the other hand, the diagrams used herein are merely intended to be schematic and auxiliary to the specification, but are not necessary to be true scale and precise configuration after implementing the present invention. Thus, it should not be interpreted in accordance with the scale and the configuration of the accompanying drawings to limit the scope of the present invention on the practical implementation.

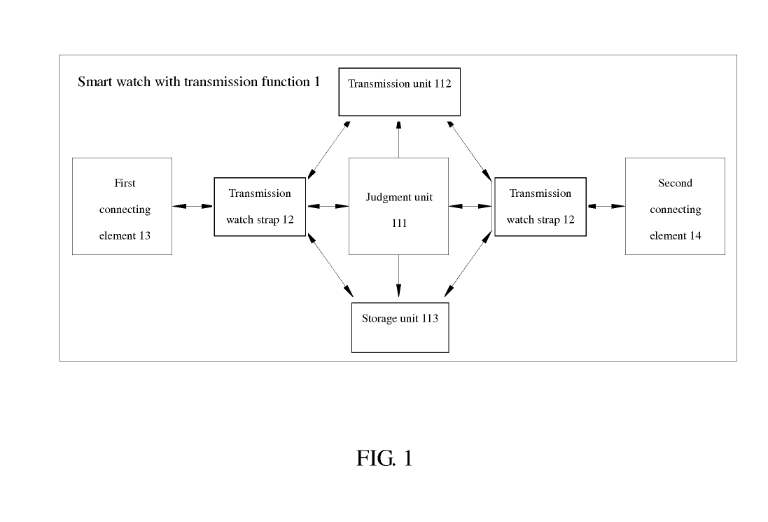

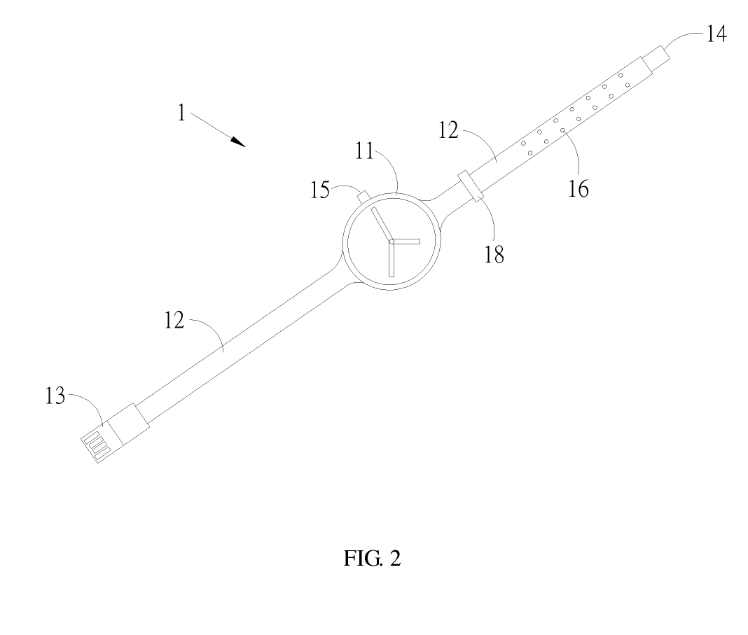

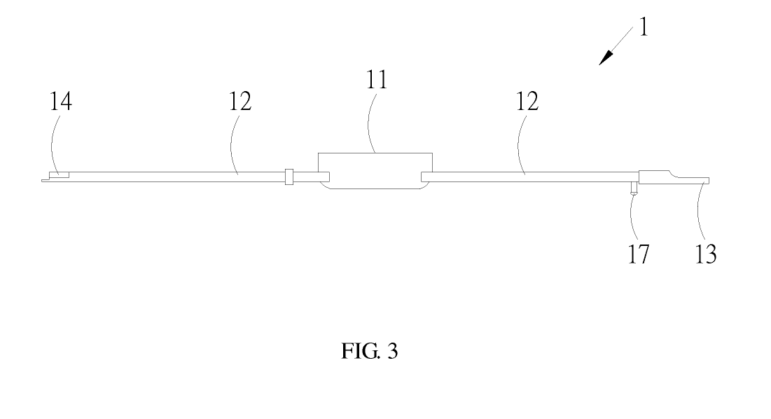

Please refer to FIG. 1 to FIG. 3; FIG. 1 is a block diagram of the smart watch with transmission function of the present invention; FIG. 2 is a front view of the smart watch with transmission function of the present invention; FIG. 3 is a side view of the smart watch with transmission function of the present invention. In the figure, the smart watch with transmission function 1 includes a movement structure 11, two transmission watch straps 12, a first connecting element 13 and a second connecting element 14. The movement structure 11 includes a judgment unit 111. The two transmission watch straps 12 connect with respect to two ends of the movement structure 11, and thereby connect to the judgment unit 111. The first connecting element 13 is disposed on one of the two transmission watch straps 12 and opposed to one end of the movement structure 11. The second connecting element 14 is disposed on another transmission watch strap 12 and opposed to another end of the movement structure 11. Wherein, when the first connecting member 13 and the second connecting member 14 of the smart watch with transmission function 1 connect to different digital devices 2 respectively, the judgment unit 111 generates a transmission signal correspondingly such that digital data is transmitted between the two digits devices 2 via the smart watch with transmission function 1. When the first connecting member 13 or the second connecting member 14 is connected to one of the two digital devices 2, the judgment unit 111 generates a storage signal correspondingly such that the smart watch with transmission function 1 stores the digital data of the digital device 2.

In addition, the movement structure 11 may further include a transmission unit 112, which is connected to the judgment unit 111 and the two transmission watch straps 12. When the transmission unit 112 receives the transmission signal, the transmission unit 112 transmits the digital data via the two transmission watch straps 12 accordingly. When the first connecting member 13 and the second connecting member 14 of the smart watch with transmission function 1 connect to different digital devices 2 respectively, the judgment unit 111 generates a transmission signal correspondingly and the smart watch with transmission function 1 is judged to perform transmission function. The transmission unit 112 is then connected and a transmission signal is sent to the transmission unit 112. At this moment, the transmission unit 112 receives the transmission signal and corresponds to the transmission signal such that the digital data is transmitted from the first digital device 2 via the first connecting member 13, the transmission watch strap 12, the transmission unit 112, another transmission watch strap 12 and the second connecting member 14 to the second digital device 2 or reversely transmitted from the second digital device 2 to the first digital device 2 to complete the transmission operation of the digital data.

Next, the movement structure 11 may further include a storage unit 113, which is connected to the judgment unit 111 and the two transmission watch straps 12. When the storage unit 113 receives the storage signal, the storage unit 113 stores the digital data via one of the two transmission watch straps accordingly. When only the first connecting member 13 or the second connecting member 14 of the smart watch with transmission function 1 is connected to one of the two digital devices 2, the judgment unit 111 generates a storage signal correspondingly and the smart watch with transmission function 1 is judged to perform storage function. The storage unit 113 is then connected and a storage signal is sent to the storage unit 113. At this moment, the storage unit 113 receives the storage signal and corresponds to the storage signal such that the digital data is transmitted from the digital′ device 2 via the first connecting member 13 or the second connecting member 14 and the transmission watch strap 12 to the storage unit 113 and stored in the storage unit 113 to complete the storage operation of the digital data.

Also, an edge of the movement structure 11 may be configured with an adjustment member 15. In general, the judgment unit 111 of the smart watch with transmission function 1 is set to perform automatic judgment operation. However, the users may also carry out manual judgment operation through the adjustment member 15 to switch to the transmission function or the storage function manually. And when used as a common smart watch, the adjustment member 15 may be used to adjust time and date.

Furthermore, one of the two transmission watch straps 12 may be configured with a plurality of fixing holes 16 and a securing member 18. Another transmission watch strap 12 may be configured with a fixing member 17 corresponding to the plurality of fixing holes 16. Thus, when the users wear the smart watch with transmission function 1, a connection point of the two transmission watch straps 12 may be fixed by inserting the fixing member 17 into the corresponding fixing holes 16 and the transmission watch strap 12 with the first connecting member 13 may be firmly secured by the securing member 18, thereby to prevent the first connecting member 13 from hitting with the external objects and resulting in damage. However, it should be understood that the way of connection for the transmission watch straps of the present embodiment is for example only, but it should not be limited thereto, the transmission watch straps may be connected to each other by way of Velcro or magnet.

Besides, the time display of the smart watch with transmission function 1 may be in pointer-type or electronic-type. The pointer-type smart watch with transmission function 1 displays time through driving a second hand, a minute hand and an hour hand by a mechanical movement structure 11. The electronic-type smart watch with transmission function 1 displays time through performing digital computing by a movement structure 11 equipped with different electronic elements.

Moreover, the two transmission watch straps 12 and the movement structure 11 may be detachable. In this way, the smart watch with transmission function 1 will be more flexible. The users may easily change the movement structure 11 to realize the pointer-type or the electronic-type time display described above according to a variety of practical needs or different preferences. And when the users need to clean the transmission watch straps 12 or the movement structure 11, the two elements may also be detached and cleaned separately in order to avoid damaging another element accidentally due to putting too much concentration on cleaning one element, and make the cleaning process more comprehensive.

On the other hand, the first connecting member 13 and the second connecting member 14 may be universal serial bus (USB). Universal serial bus is the most commonly used interface connector for the current digital devices. Therefore, the smart watch with transmission function 1 equipped with universal serial bus is applicable to the connections with most of the digital devices. The type of the first connecting member 13 and the second connecting member 14 may be the same or different. For example, the first connecting member 13 and the second connecting member 14 may be the same as Mini USB; or the first connecting member 13 may be Mini USB and the second connecting member 14 may be Micro USB. However, it is should be noted that, the interface connectors of the present embodiment are for example only, but it should not be limited thereto.

In addition, the movement structure 11 of the smart watch with transmission function 1 may further include a power supply unit as a driving power of the smart watch with transmission function 1. The user may charge up the smart watch with transmission function 1 through connecting the first connecting member 13 or the second connecting member 14 to the digital device 2.

Apart from this, the smart watch with transmission function 1 not only can be charged up, but also can help charge up other digital devices 2. When the first connecting member 13 is connected to a power transformer, a mobile power bank or other charging equipment and the second connecting member 14 is connected to the digital device 2, or vice versa, when the second connecting member 14 is connected to the power transformer, the mobile power bank or other charging equipment and the first connecting member 13 is connected to the digital device 2, the power supply or the charging equipment can charge up the digital device 2 via the smart watch with transmission function 1. Thus, the smart watch with transmission function 1 can transmit the digital data and/or charge up the digital device; or can perform both at the same time. In other words, the smart watch with transmission function 1 has the same functions as the transmission lines which are generally used at present.

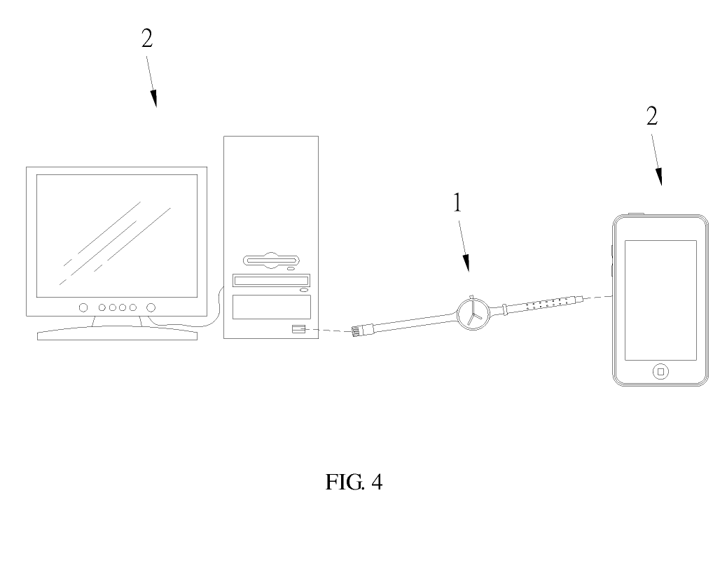

Please refer to FIG. 4; FIG. 4 is a schematic view of operation for the smart watch with transmission function of the present invention. In general, when the users actually use the smart watch with transmission function 1 of the present invention, the smart watch with transmission function 1 is worn on a wrist for viewing time in most cases. Therefore, when the users need to transmit or store digital data, the smart watch with transmission function 1 is firstly taken from the wrist.

Since the first connecting member 13 and the second connecting member 14 are used for connecting different digital devices 2 respectively, after the user taking the smart watch with transmission function 1 from the wrist and before connecting to the digital devices 2, the type of connection port of the digital devices 2 has to be identified. The corresponding first connecting member 13 or second connecting member 14 is then inserted to the connection port according to the type of connection port.

When the first connecting member 13 and the second connecting member 14 of the smart watch with transmission function 1 are inserted to connection ports of two different digital devices 2 at the same time, the judgment unit 111 generates a transmission signal correspondingly and the smart watch with transmission function 1 is judged to serve for transmission use. The transmission unit 112 is then connected and a transmission signal is sent to the transmission unit 112. Next, the transmission unit 112 receives the transmission signal and corresponds to the transmission signal such that the digital data is transmitted from the first digital device 2 via the first connecting member 13, the transmission watch strap 12, the transmission unit 112, another transmission watch strap 12 and the second connecting member 14 to the second digital device 2, or the digital data is reversely transmitted from the second digital device 2 via the second connecting member 14, another transmission watch strap 12, the transmission unit 112, the transmission watch strap 12 and the first connecting member 13 to the first digital device 2. Then, after the transmission of the digital data being completed, the users may pull out the first connecting member 13 and the second connecting member 14 of the smart watch with transmission function 1 from the connection ports of the two digital devices 2 and wear the smart watch again.

When only the first connecting member 13 or the second connecting member 14 of the smart watch with transmission function 1 is inserted to connection port of one of the two digital devices 2, the judgment unit 111 generates a storage signal correspondingly and the smart watch with transmission function 1 is judged to serve for storage use. The storage unit 113 is then connected and a storage signal is sent to the storage unit 113. Next, the storage unit 113 receives the storage signal and corresponds to the storage signal such that the digital data is transmitted from the digital device 2 via the first connecting member 13 or the second connecting member 14 and the transmission watch strap 12 to the storage unit 113 and stored in the storage unit 113. Or, when the users perform the reading operation of the digital data in the digital device 2, the judgment unit 111 generates a reading signal correspondingly and the smart watch with transmission function 1 is judged to serve for reading use. The storage unit 113 is then connected and a reading signal is sent to the storage unit 113. Next, the storage unit 113 receives the reading signal and corresponds to the reading signal such that the digital data stored in the storage unit 113 is transmitted from the storage unit 113 via the transmission watch strap 12 and the first connecting member 13 or the second connecting member 14 to the digital devices 2. Then, after the storage or reading of the digital data being completed, the users may pull out the first connecting member 13 or the second connecting member 14 of the smart watch with transmission function 1 from the connection port of the digital devices 2 and wear the smart watch again.

It should be understood that, when the first connecting member 13 and the second connecting member 14 of the smart watch with transmission function 1 are inserted to connection ports of two different digital devices 2 respectively, the first connecting member 13 and the second connecting member 14 may generate a judgment signal respectively and transmit the judgment signals to the judgment unit 111 via the transmission watch strap 12. The judgment unit 111 receives the two judgment signals simultaneously, such that the judgment unit 111 identifies that both the first connecting member 13 and the second connecting member 14 are connected to the digital devices 2 after judgment and then generates a transmission signal correspondingly in order to perform the transmission of the digital data. And when only the first connecting member 13 or the second connecting member 14 of the smart watch with transmission function 1 is inserted to connection port of one of the two digital devices 2, the first connecting member 13 or the second connecting member 14 connecting to the digital device 2 may also generate a judgment signal correspondingly and transmit the judgment signal to the judgment unit 111 via the transmission watch strap 12. The judgment unit 111 receives the judgment signal, such that the judgment unit 111 identifies that either the first connecting member 13 or the second connecting member 14 is connected to the digital devices 2 after judgment and then generates a storage signal correspondingly in order to perform the storage of the digital data. However, the present embodiment is for example only, but it should not be limited thereto.

According to the configuration of the smart watch with transmission function of the present invention, the users may prevent from trouble in using an extra transmission line through connecting to various digital devices by the transmission watch straps and transmitting the digital data by the transmission watch straps and the transmission unit. On the other hand, the storage unit provides a digital data storage space to the users. The users may create backup data for important digital data. When the users are in need, the backup data may be read as a reference. Also, the judgment unit may be switched to the transmit function or the storage function automatically or manually to transmit or store the digital data based on the needs of the users. In addition, since people are used to wear watches, the smart watch combining with the transmission and the storage functions may solve the problem of forgetting to carry flash drive or transmission line.

In conclusion, the smart watch with transmission function of the present invention is a product which is hardly reached by the conventional technology and actually can achieve the effects of the improvement. It is difficult for those who are familiar with the techniques to think of. The progressiveness and the practicality thereof apparently meet the requirements of the patent application and thus this patent application is now submitted based on the patent law. May this patent application be approved for encouragement of the present invention; your kind consideration would be highly appreciated.

What is claimed is:

1. A smart watch with transmission function, comprising:
a movement structure, comprising a judgment unit;
two transmission watch straps, connecting with respect to two ends of the movement structure, and thereby connecting to the judgment unit;
a first connecting element, disposed on one of the two transmission watch straps and opposed to one end of the movement structure; and
a second connecting element, disposed on another transmission watch strap and opposed to another end of the movement structure;
wherein, when the first connecting member and the second connecting member of the smart watch with transmission function connect to a digital device respectively, the judgment unit generates a transmission signal correspondingly, such that digital data is transmitted between the two digits devices via the smart watch with transmission function, when the first connecting member or the second connecting member is connected to one of the two digital devices, the judgment unit generates a storage signal correspondingly, such that the smart watch with transmission function stores the digital data of the digital device.

2. The smart watch with transmission function of claim 1, wherein the movement structure further comprises a transmission unit, which is connected to the judgment unit and the two transmission watch straps, when the transmission unit receives the transmission signal, the transmission unit transmits the digital data via the two transmission watch straps accordingly.

3. The smart watch with transmission function of claim 1, wherein the movement structure further comprises a storage unit, which is connected to the judgment unit and the two transmission watch straps, when the storage unit receives the storage signal, the storage unit stores the digital data via one of the two transmission watch straps accordingly.

4. The smart watch with transmission function of claim 1, wherein an edge of the movement structure is configured with an adjustment member.

5. The smart watch with transmission function of claim 1, wherein one of the two transmission watch straps is configured with a plurality of fixing holes.

6. The smart watch with transmission function of claim 5, wherein another transmission watch strap is configured with a fixing member corresponding to the plurality of fixing holes.

7. The smart watch with transmission function of claim 1, wherein one of the two transmission watch straps is configured with a securing member.

8. The smart watch with transmission function of claim 1, wherein time display of the smart watch with transmission function is in pointer-type or electronic-type.

9. The smart watch with transmission function of claim 1, wherein the two transmission watch straps and the movement structure are detachable.

10. The smart watch with transmission function of claim 1, wherein the first connecting member and the second connecting member are universal serial bus.
